(19) United States
(12) Patent Application Publication
(10) Pub. No.: US 2005/0043988 A1
(43) Pub. Date: Feb. 24, 2005

(54) Survey of information about a vote

(75) Inventors: Martin Illsley, Magagnosc (FR); Jonathan Kaldor, Essex (GB); David Berglund, Villeneuve Loubet (FR); Loic Feinbier, Le Cannet (FR)

Correspondence Address: MORRISON & FOERSTER LLP, 425 MARKET STREET, SAN FRANCISCO, CA, 94105-2482, US

(73) Assignee: Accenture Global Services GmbH, Switzerland (CH)

(21) Appl. No.: 10/494,158

(22) PCT Filed: Oct. 30, 2002
(86) PCT No.: PCT/EP02/13164

(30) Foreign Application Priority Data
Oct. 31, 2001 (EP) 01410144.8

(51) Int. Cl. G06F 17/60

(52) U.S. Cl. 705/12

(57) ABSTRACT

A computer based method and system for automatically managing votes, comprising the steps of collecting the votes of persons about a given subject, collecting a time information, combining the results of the votes with the time information; and displaying in real-time the vote results to a target person acting on the given subject.

### FIELD OF THE INVENTION

The present invention relates to a computer based system and method for surveying information about votes of people concerning a subject (an object, a service, an event, a presentation, etc.). More specifically, the invention relates to an automatic system and method for relaying in real-time a vote and some other parameters to a target person of the surveyed subject.

### BACKGROUND OF THE INVENTION

In a first example of application, the present invention provides to a retailer or shop keeper real-time information about the opinion of customers in a mall or a shop. Today, shoppers have no easy mechanism to give their opinion about a shop or a mall to the retailer. They can only file complaint forms, which have the drawbacks of not being really anonymous and of requiring efforts from the customer and the target person. Further, feedback from a customer may be lost. It is also not real-time.

An approach which comes in mind to one who wishes to capture a real-time vote of customers in a mall or a shop is to use, in different places in the mall, push-buttons at disposal to customers. A first button corresponds to positive votes, and a second button corresponds to negative votes. The number of pushes might be collected by a computerized system to display the instant votes of the customers.

However, instant feedback of customers may be polluted by environmental parameters (for example, the ambient temperature, the affluence in the shop, etc.). Further, these parameters may vary quickly (for example, the affluence in a particular lane of the shop) and the results would not be in relation with such parameters.

In another example, the present invention applies to a lecturer wishing to know the real-time satisfaction votes of his/her audience during their presentation. Such information may serve the lecturer to dynamically adapt their presentation according to satisfaction votes. A normal presentation can then be more interesting and interaction between the audience and the presenter or lecturer is enabled. This may also enhance the capability of the presenter to identify the needs of their audience during the presentation.

There is a need for an automated, computationally efficient, method and system for collecting satisfaction votes in such applications, and to efficiently generate real-time information corresponding to satisfaction votes or instant feedback of people.

A technical problem exists in relaying to a target person instant satisfaction votes of people regarding products, environment, presentation, conferences, etc. where the object of the vote is ephemera and/or influenced by the environment of the voting people.

Automatic voting systems are already known, for example, for elections. These systems are able to give, as a function of time, the number of voters. However, such systems do not give information about the vote results taking into account the time or environmental parameters.

WO-A-9811494 discloses a system for correlating data relative to a video image of a person making a presentation. Such a system provides statistical analysis especially for market research. However, it does not generates real-time information for the presenter.

U.S. Pat. No. 5,226,177 discloses a wireless audience response system for TV. Such a system does not take into account the environment of the respondents. Further, there is no interaction between the presented data and a presenter.

U.S. Pat. No. 5,950,172 discloses a voting system through internet without any dynamic interaction with a presentation.

WO-A-0052611 discloses a data collection system.

U.S. Pat. No. 5,615,134 discloses a system of polling and data collection relative to the temperature and is used to modify the temperature.

WO-A-0131589 discloses a voting system relative to specific questions asked to the voters.

A purpose of the present invention is to provide a system and a method for transmitting information about a satisfaction vote, while taking into account the environment of the voting people and/or the instants where the votes appear.

Another purpose of the present invention is to inform in real-time the target user of the voting choices.

Another purpose of the present invention is to allow a user (a customer or a listener) to easily register their level of satisfaction with regards to a subject such as a service, quality, a value and so on, and to immediately transmit this feedback to a target in order to dynamically interact with the subject.

Another purpose of the present invention is to link the votes with the environment of the voters.

### BRIEF SUMMARY OF THE INVENTION

To attain the above purposes and others, the present invention provides a computer based method and system for automatically managing votes.

According to the present invention, one collects not only the votes of persons about a given subject, but also time information. This time information may either be directly the current time or a time window within which the persons are intended to vote. Multiple votes of a same person may or not be allowed.

According to a preferred embodiment of the present invention, the environment of the vote is also taken into account. In other words, the vote results are also combined with at least one environmental parameter such as the temperature, the affluence, the moisture, etc. The environmental parameter information can be used to define a maximum or a minimum threshold to take into account or disregard a vote. Alternatively, one defines a window of values of the environmental parameter outside of which, when a vote appears, it is considered as not significant.

More preferably, the results of the vote are displayed in real-time to a target person of the subject of the vote. The subject of the vote may be an object, a service, an event, a presentation or a presentation part, and more generally any virtual or real subject which can be appreciated with a vote. Further, the results of the vote interact with the subject. Especially for a presentation, the results are displayed along with the presentation itself on a control screen dedicated to the presenter or on the screen on which is displayed the presentation.

According to a preferred embodiment of the present invention, one uses the voting devices for anonymous votes.

### DESCRIPTION OF THE DRAWINGS

These purposes, features and advantages of preferred, non limiting, embodiments of the present invention will be described by way of example with reference to the accompanying drawings, in which:

FIG. 1 schematically represents the main elements of one exemplary embodiment of the system according to the present invention, applied to a conference system;

FIG. 2 schematically represents the main elements of a voting system according to an exemplary embodiment of the present invention;

FIG. 3 illustrates a presentation screen of a voting system according to one exemplary embodiment of the present invention; and

FIG. 4 schematically represents the main elements of another exemplary embodiment of the system according to the present invention, applied to an instant customer feedback in a mall.

For clarity, only the elements useful to the understanding of the invention have been shown in the drawings. Especially, details of the programming steps according to the system of the invention will not be detailed as it will readily occur to those skilled in the art.

### DETAILED DESCRIPTION

A feature of the present invention is to synchronize the votes of people with a timing sequence relating to the subject one wants to survey. For example, in connection with conference, the votes of the audience and the timing of the presentation made by the lecturer are synchronized. In the application of surveying the opinion of customers in a mall, that feature means that the different votes of the people in the various places of the mall are displayed or stored with information about events which happened in the environment of the customers.

Another feature of a preferred embodiment of the present invention is to collect information about environmental parameters of voting people and to, if necessary, correct the vote's results with respect to these environmental parameters. For example, if the temperature in a mall suddenly increases, the votes might be negative due to the temperature increase and not due to the subject to be evaluated. The temperature, as environmental parameter, is not used “directly” as for example in U.S. Pat. No. 5,615,134 cited above to modify the temperature of the room, but is used “indirectly” to analyse and/or modify the results of the vote if a vote might be influenced by the temperature. According to the invention, the environmental parameter is not the subject of the vote.

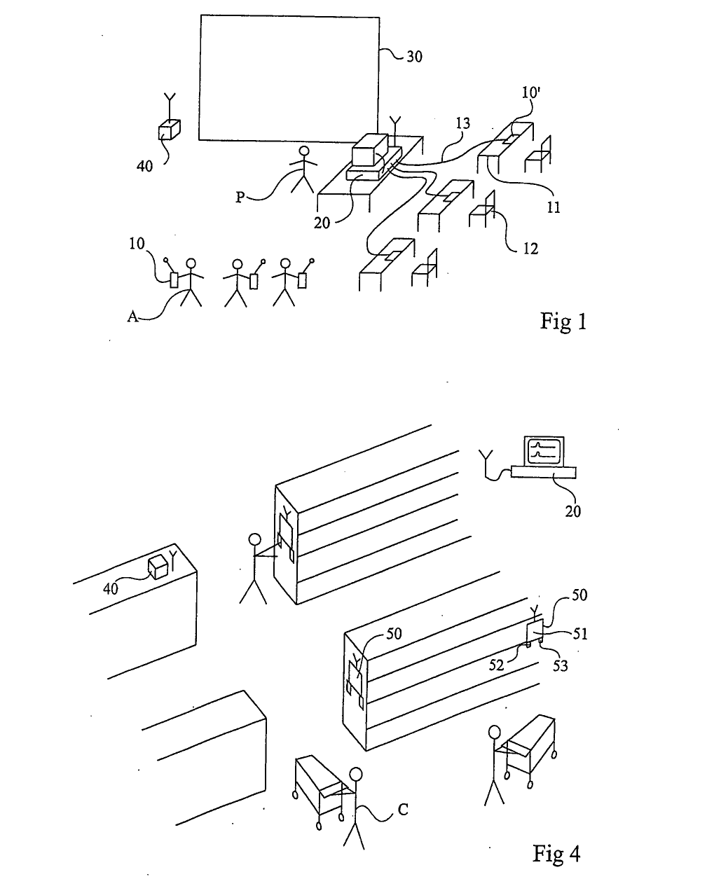

FIG. 1 schematically represents one exemplary embodiment of the system according to the present invention, applied to survey information relating to the satisfaction votes of audience in a conference.

Each listener A of the conference is equipped with a voting device. Such a voting device can be a handset device 10 or a resident device 10′ associated with tables 11 of the room. The voting devices comprise satisfy and dissatisfy buttons which are, for example, toggle buttons. Preferably, when no button is selected during a voting session, that means an indifferent opinion. Each device 10 or 10′ is connected to a central system 20 (for example, a personal computer) for collecting the information and synchronizing the votes with the sequence of the presentation. For example, the personal computer constituting the central system is also used by the presenter P to control the displaying of his presentation on a screen 30. The central system includes a database server for the storage of all the voting sessions for a future review purpose.

According to the invention, the results of the vote are used to dynamically help the presenter. The results are preferably integrated, in real-time, to the presentation, at least on a control screen dedicated to the presenter, but, the presentation is not interrupted.

A maximum of one voting session shall be displayable as current session. Also, a voting session in such an application shall be limited to a period of time (i.e. all votes must be made within a predetermined time window). For example, the time window may correspond to the duration of the display of a specific view.

No restriction has to be imposed about how many users will participate in a specific vote with the devices 10 and 10′.

Handset devices 10 are, for example, pocket PC or any personal assistant (PDA). Such an embodiment requires that specific application is launched on the personal assistant to first establish a local network connection. For example, the invention can be implemented with Bluetooth connections.

Bluetooth is an open standard for a short range transmission of digital voice and data between mobile devices (Palms, PDAS, phones) and desktop devices. Connection can be point-to-point or multipoint.

As soon as the Bluetooth connection is established, the software application contacts the server 20, retrieves the active vote session and starts to display, on the handset device, a first dialog in the sequence. If a time limit is defined for the voting session, the remaining time shall be permanently visible on the screen of the handset device and/or on screen 30.

The user's selection (vote) can then be sent back to the server 20 and stored in the central database for further processing by the presenter.

Preferably, the system is anonymous (with a personal assistant, users must feel that nobody can observe them while voting). For example, the position of the satisfy/dissatisfy buttons is randomly alternating for each new voting session or periodically, so that no-one can guess others' opinion by having a look at where/when they tap on the screen, and the name of the user will not be shown on the presentation screen of the central system 20.

The central system or visualization computer 20 is, for example, a personal computer with a software application providing a user interface leading into a control panel. For example, the control panel floats on top of the presentation slice and has some options to select and display the results of any active or historical voting session from the central system.

When the currently active session is selected, results shall be permanently updated and visualized in real-time.

Any presentation format could be provided and the presenter shall have options to control and modify each vote session and its display.

According to a preferred embodiment of the present invention, the control system also takes into account at least an environmental parameter such as, for example, temperature or moisture. The room is then provided with a sensor 40 associated with a system to transmit measurements to the central system. For example, the sensor 40 shall use a local wireless connection such as the connection used by the handset devices 10.

Alternatively, the sensor shall have a wired connection (not shown). The resident voting devices 10′ provided in the room, for example on the top of the table 11 associated with seats 12 for the listeners, can be linked to the central system 20 either with a wired connection 13 or with a wireless connection.

With an environmental sensor, the environmental parameter is stored with the vote results in order to indicate if there are particular reasons for which a vote might not be representative of the real opinion of the audience.

For example, one can predetermine two thresholds of temperature (maximum and minimum thresholds) between which the temperature of the room is to be considered as normal. If a voting session appears in a period in which the temperature is outside of the predetermined window, the central system displays that information with the vote results to indicate to the presenter that these results might significantly be biased by this effect.

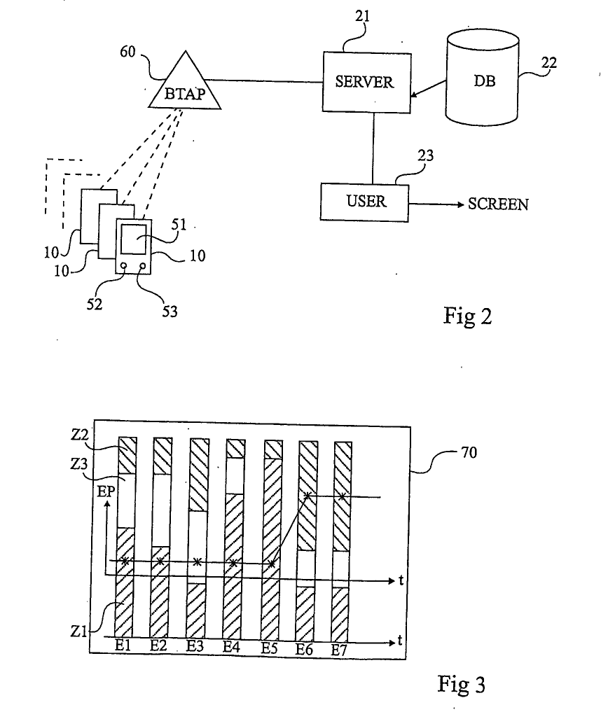

FIG. 2 represents one exemplary embodiment of the architecture of a system according to the present invention. According to this embodiment, voting people have handset devices 10 with at least a screen 51 and two buttons 52 and 53. Buttons 52 and 53 might also be on-screen buttons. For example, device 10 is a personal assistant or a mobile phone or a dedicated voting device. Each device is wireless connected to a Bluetooth access point 60 (BTAP) which is interconnected to a central server 21 (SERVER). The link between the Bluetooth access point 60 and the central server 21 might be a wired connection or a wireless connection. Several Bluetooth access points 60 can be connected to a single server 21. Server 21 is, for example, part of a central system 20 (FIG. 1 or 2) and is connected to a database 22 or any other storage element. Server 21 is also connected to a user terminal 23 (USER). In the embodiment of FIG. 2, a server 21 and a user device 23 are combined in central control system 20. The user device 23 is provided with a screen (SCREEN) to display the vote results.

The operation of such architecture is for example as follows.

A presenter first starts the system by creating a new voting session at the user device. He enters the title and the duration of the voting session. This command is sent to the database server 21 and a new session database record is created. The system is now ready for accepting request from the handspring devices 10 connected to the Bluetooth access point 60.

The user's handspring devices will try to connect to the Bluetooth access point automatically when the user application is activated. This Bluetooth connection is initiated by the user application. The establishment of the connection is hidden to the user.

In case of the Bluetooth access point system, some kind of filtering is needed so that only the devices of the listeners are available for connection.

When this connection is established, the user's application sends a request for initialization. The reply for server 21 will be a message with a list of initialization parameters such as the title of the presentation and the available choices of selection for the voting session.

The start of the voting session is preferably initiated by the presenter from the user device 23. The presenter can also press a stop button to temporarily suspend all the voting sessions during a period of his presentation.

A multiple vote of a same person may or not be allowed. If not, the voting devices are identified and a single vote of a given voting device is taken into account during each vote session.

FIG. 3 shows an exemplary embodiment of a display representation 70 of vote results during a presentation. In FIG. 3, one illustrates seven subjects E1, E2, E3, E4, E5, E6 and E7, or voting sessions during the time. The votes are displayed in columns or histograms. Each histogram represents hundred percent and is divided into at least two areas. A first area Z1 corresponds to the satisfactory votes, and a second area of each histogram Z2 corresponds to the dissatisfactory votes. An eventual intermediate third area Z3 corresponds to the indifferent opinions that are preferably the number of auditors which do not push any button during the voting session period.

According to the preferred embodiment of the present invention, an environmental parameter EP is also displayed in the results 70. FIG. 3 illustrates a curve representing as a function of time, the value of the environmental parameter, for example the temperature. In the example of FIG. 3, the temperature is constant for voting sessions E1 to E5. But the temperature increases in voting sessions E6 and E7. The presenter can then consider that the negative votes of sessions 6 and 7 are not representative of the real opinion of the audience.

The implementation of the invention, with the synchronization mechanism and the software to take into account the environmental parameters, are in the ability of those skilled in the art.

An advantage of the present invention is that the presenter of a conference is able to determine which parts of his presentation are satisfactory or not. The synchronization between the presentation and the voting sessions allows the presenter to exactly know in real-time the corresponding part of his conference.

Another advantage of the present invention is that, if an environmental perturbation (such as temperature, moisture, noise, light, etc.) occurs, the system stores and/or displays that information to the presenter himself with the corresponding voting session if any. Then, the presenter might be able to immediately determine if the voting session is relevant or not. Alternatively, one can also provide to automatically disregard a voting session for which an environmental parameter is outside a predetermined window of values.

Preferably, no specific question is asked, i.e. the users just indicate, along with the time, their satisfaction/dissatisfaction. Further, in order to take into account the environmental parameter, the voters are not remote from the place of the presentation (or subject of vote). The invention applies to physical places of vote and not to distant votes through internet for example.

FIG. 4 represents one exemplary embodiment of the present invention applied to collecting votes of customers in a shop or a mall.

According to this embodiment, a central control system 20 is connected to voting devices 50 which are disposed in particular places of the shop or of the mall. For example, a voting device shall be placed at the vicinity of a new presentation of products in the lanes, in order to collect the opinions of the customers. As in the preceding embodiment, the devices might be connected to the central system either with wired or wireless connections. In FIG. 4, wireless connections have been represented.

Preferably, at least one environmental parameter's sensor 40 linked with the central system 20 is provided in the vicinity of the devices. If the environmental parameter may change in a limited area, each device 50 is provided with a sensor.

Customers C, when they walk through the lanes of the shop, have the possibility to vote with one of the voting devices 50. Depending on the question of the vote, the voting devices can correspond to different votes. Preferably, each device 50 comprises a screen to display the question on which vote is asked. The control of the display 51 is made, for example, by the central system 20. Each device also comprises two buttons 52 and 53 corresponding to satisfactory and dissatisfactory buttons, respectively. These buttons might also correspond to on-screen buttons like in a personal assistant, or to any other known means to sense a satisfactory/dissatisfactory opinion.

Alternatively, voting devices can be personal assistant or, more preferably, mobile phones of customers linked with a Bluetooth connection to the central system.

An advantage of the present invention in this application is that the shop keeper, or more generally, the person to whom is dedicated the vote results and to which the results of the vote are delivered in real-time, may adapt his commercial offer very quickly.

Another advantage is that the vote results take into account some environmental parameters. In a shop or mall, one environmental parameter which can be provided is the affluence in the area of the voting device.

In the application of a customer's feedback in a mall or shop, the system of the invention allows a customer to very easily (and anonymously) register his level of satisfaction with regards to subjects such as customer service, quality, value and so on, at the time of the purchase (or of the aborted purchase). This feedback may be immediately relayed to the target person who can act on the situation if necessary.

Comparatively to a manual solution, the present invention has a lot of advantages, among others, it is easy, it guarantees anonymous votes, and a feedback may not be lost.

Having thus described at least two illustrative embodiments of the invention, various alterations, modifications and improvements will readily occur to those skilled in the art. Such alterations, modifications, and improvements are intended to be within the spirit and scope of the invention. Accordingly, the foregoing description is by way of example only and is not intended to be limiting. In particular, the invention may be applied to any situation where instant feedback may be collected and relayed to the target of the feedback in real-time. Further, the implementation of the invention with hardware/software components is in the ability of those with an ordinary skill in the art. The invention is limited only as defined in the following claims and the equivalents thereto.

1. A computer based method for automatically managing votes, comprising the steps of:
collecting the votes of persons about a given subject;
collecting time information;
combining the results of the votes with the time information; and
displaying in real-time the vote results to a target person acting on the given subject.

2. The method of claim 1, further comprising the steps of:
collecting information about at least one environmental parameter of the voting persons, said parameter being different from the subject of the vote; and
combining the results of the parameter information with the results of the vote.

3. The method of claim 2, further comprising the steps of:
determining a window of acceptable values of the environmental parameter; and
indicating and/or not taking into account the votes occurring when the current value of the environmental parameter is out of said window.

4. The method of claim 1, wherein the subject of the vote is the satisfaction of a current event or service.

5. The method of claim 1, comprising several voting sessions of limited duration.

6. The method of any of claims 1 to 5, applied to survey customer satisfaction votes in a shop, a mall or similar.

7. The method of any of claims 1 to 5, applied to survey a satisfaction vote of an audience during a presentation.

8. A computer based system for automatically monaying votes comprising:
voting devices (10, 10′, 50) to acquire votes about a given subject;
a central control device (20) to collect votes sent by the voting devices;
means to combine the results of the votes with a time information; and
means to display in real-time the vote results to a target person acting on said subject.

9. The system of claim 8, further comprising at least one environmental parameter sensor (40), the results of which are collected by the central control system (20), said parameter being different from the subject of the vote.

10. The system of claim 8 or 9, wherein the connections between the voting devices (10, 10′, 50) and the central control device (20) are wireless connections.

11. The system of any of claims 8 to 10, wherein the voting devices are handset devices (10).

12. The system of any of claims 8 to 10, wherein the voting devices are resident devices (10′).
